(19) United States
(12) Patent Application Publication
(10) Pub. No.: US 2018/0284886 A1
(43) Pub. Date: Oct. 4, 2018

(54) Computer-Implemented Method of Recovering a Visual Event

(71) Applicant: ITU Business Development A/S, København S (DK)

(72) Inventors: Diako MARDANBEGI, Nivå (DK); Shahram JALALINIYA, Lund (SE); John Paulin HANSEN, Roskilde (DK)

(21) Appl. No.: 15/762,715

(22) PCT Filed: Sep. 26, 2016
(86) PCT No.: PCT/EP2016/072810

§ 371 Date: Mar. 23, 2018

Related U.S. Application Data
(60) Provisional application No. 62/232,619, filed on Sep. 25, 2015.

(30) Foreign Application Priority Data
Feb. 29, 2016 (EP) 16157863.8

(51) Int. Cl. G06F 3/01; G06F 3/0485; G06F 3/0487

(52) U.S. Cl. CPC G06F 3/013; G06F 3/0487; G06F 3/0485

(57) ABSTRACT

A computer-implemented method and a computer of recovering a visual event, comprising: by means of a graphical user interface, the contents of a viewport is displayed to a user as the viewport is progressively moved across graphical portions of a visual media object; while the contents of the viewport is displayed, recording an eye movement signal that is indicative of the movements of a user's at least one eye, classifying temporal sections of the eye movement signal into at least a class of long slow-phase OKN eye movements occurring among short slow-phase eye movements; setting a synchronization marker at least for a first occurrence of a temporal section classified as a smooth pursuit eye movement; wherein the synchronization marker comprises a link to or impression information of the contents of the viewport at the point in time when the first occurrence of a smooth pursuit eye movement occurred; via the synchronization marker, recovering the impression information or the contents of the viewport that was displayed at the point in time when the first occurrence of the smooth pursuit occurred.

### INTRODUCTION/BACKGROUND

People, human users of digital media, scroll through or browse vast amounts of digital information on electronic devices, such as mobile devices like smartphones, with textual and graphical contents e.g. enabled by Internet applications (software) providing interaction via social networks.

People have learned to scan the digital information by quickly moving their eyes across the contents and picking particular content that seem more interesting to us for further observation or interaction.

The fact that our brains processes images significantly faster than text may be one of the reasons why we are often more engaged with images than textual information and why viewing pictures is among the most popular activities enabled by social networks like Facebook.

When people are browsing their Facebook page on their mobile device, it's often that they quickly scan the Newsfeed by scrolling down or up the Facebook page until they find some interesting information. However, scrolling for navigation on small-screen devices has its own usability and inefficiency problems. In this respect the main steps of browsing the content is a) scrolling, b) stopping the page, and c) bringing the desired content back to the display by scrolling back up are the main parts of browsing the contents.

We go through the same steps when we search for a particular image in our photo gallery. Our ability to rapidly scan and process the visual cues that are quickly moving before our eyes enable us to speed up the scrolling task. However, the third step (c), i.e. bringing the desired content back, can be a cumbersome task for users when scrolling is fast since it requires a very high coordination between our eyes, brains and motor control system (e.g. touching the display with our fingers). Finding the desired image that has gone out of the screen during a fast scrolling is not always easy and it sets a limitation to how fast the scrolling can be done.

In general, using eye gaze as an input modality for computing devices has long been a topic of interest in the human-computer interface, HCl, community, and it is due to the fact that humans naturally tend to direct eyes toward the target of interest. Eye gaze can be used both as an explicit and implicit input modality.

Implicit input are actions of humans, which are performed to achieve a goal and are not primarily regarded as interaction with a computer, but captured, recognized, and interpreted by a computer system as input. While explicit inputs are our intended commands to the system through mouse, keyboard, voice commands, body gestures, and etc.

### RELATED PRIOR ART

Eye gaze as an explicit input: One of the most explored explicit ways of using gaze to interact with computers is to use eye gaze as a direct pointing modality instead of a mouse in a target acquisition task. The target can be selected either by fixating the gaze for a while on a particular area (dwell-time) or using a mouse click or gesture. However, controlling a cursor with eye movements is limited to pointing towards big targets due to the inaccuracy of gaze tracking methods and subconscious jittery motions of the eyes. Eye-gesture is another explicit approach for gaze-based interaction where user performs predefined eye strokes. Studies have shown that using eye gaze as an explicit input modality is not always a convenient method for users. In fact, overloading eyes as humans' perceptual channel with a motor control task is not convenient.

Eye gaze as an implicit input: In implicit methods of using gaze in user interface design, natural movements of the eyes can be used to detect context, for example looking at certain objects in an environment can reveal interest of humans to those objects. Eye gaze can also be used to infer information about a user's behaviour, for instance which objects attracts user attention during an everyday activity like cooking. Another example of using eye gaze as an implicit input is to detect user's attention point and react to the user's eye contact. The gaze data can also be used indirectly for interaction purposes. For instance, in the so-called MAGIC pointing technique, eye gaze data is used to move the cursor as close as possible to the target.

Mélodie Vidal et al. proposed a pursuits interaction technique wherein an object is automatically selected by correlating an eye pursuit movement pattern with moving object's movement patterns and selecting the object that has a movement pattern that correlates best with the eye pursuit movement pattern. The technique was published in their article: “Pursuits: spontaneous interaction with displays based on smooth pursuit eye movement and moving targets” in Proceedings of the 2013 ACM international joint conference on Pervasive and ubiquitous computing, ACM, 439-448. The accuracy of their proposed technique depends on the difference of trajectories which means it fails to detect unidirectional moving objects possibly due to the similarity of the trajectories in a unidirectional movement.

US 2012/131491-A1 describes an apparatus with a display for displaying text and with an eye information detection unit configured to detect eye movement signal indicative of movements of the eyes of a user and an eye movement/content mapping unit configured to generate an eye movement trajectory that is based on the detected eye movement signal. The eye movement trajectory is processed to generate reading information by mapping the generated eye movement trajectory to text content, wherein the reading information indicates how and what part of the text content has been read by the user. A content control unit is configured to control the text content based on the generated reading information such as to ‘flip pages’ and insert a bookmark if the user's gaze dwells on a text area for sufficiently long time. However, US 2012/131491-A1 fails to describe a method that would make it possible to register a relevant portion in a media stream with moving visual content in such a way that the relevant portion can be subsequently recovered.

US 2014/347265-A1 describes a wearable computing device wherein measurements may be obtained by sensors positioned on either side of the nose bridge, or sensors positioned on the inside and outside edges of the eyes on the lateral plane. At least some of these sensors may measure electrooculography, EOG, to track eye saccades. In one example, EOG measurements could be used by the wearable computing device to determine whether the user has looked at a recent message. If the wearable computing device makes such a determination, an action could be performed such as clearing the message once the user has looked at it. When playing audio or video media, the wearable computing device may measure wave data and use that data to indicate the salience of an event in the media stream. The portion of the video or audio that corresponds to the firing is tagged accordingly. The user may then jump back to the tagged data, which would have represented something that was salient to the user, meaning it is more likely content the user was interested in reviewing. This may be an effective way to manage reviewing long streams of video/audio. However, US 2014/347265-A1 fails to describe how to reliably register a relevant portion in a media stream with moving visual content using an eye movement signal in such a way that the relevant portion can be subsequently and reliably recovered.

### SUMMARY

The claimed computer-implemented method enables computer devices to detect an object of interest among unidirectional moving objects.

At sufficiently fast scroll speeds such as those greater than a threshold speed, the user may only at a later point in time consciously note that some interesting content appeared on a display displaying a stream of objects e.g. in connection with scrolling—and at that time the interesting content that was displayed is passed since the viewport was quickly moved to an advanced position in the stream of objects.

However, as claimed, it is possible to recover the content, a link thereto or an impression of the content that was displayed, but is not displayed any longer, by processing a signal indicative of the user's eye movements at times when the user is scrolling or viewing the content.

There is provided a computer-implemented method of recovering a visual event, comprising:
by means of a graphical user interface, the contents of a viewport is displayed to a user as the viewport is progressively moved across graphical portions of a visual media object;
while the contents of the viewport is displayed, recording an eye movement signal that is indicative of the movements of a user's at least one eye;
classifying temporal sections of the eye movement signal into at least a class of smooth pursuit eye movements occurring among saccadic eye movements;
setting a synchronization marker at least for a first occurrence of a temporal section classified as a smooth pursuit eye movement; wherein the synchronization marker comprises a link to or impression information of the contents of the viewport at the point in time when the first occurrence of a smooth pursuit eye movement occurred; and
via the synchronization marker, recovering the impression information or the contents of the viewport that was displayed at the point in time when the first occurrence of the smooth pursuit occurred.

Thus, transient graphical content is displayed and the particular transient content that was displayed when a user's eye movement showed an interest is recovered immediately or at later point in time. In this way a fast way of retrieving information is provided when the computer-implemented method is run. The user can use his eyes to view the content without performing learned gestures and still have particular content recovered.

The eye movement signal may be recorded by an eye tracker also denoted a gaze tracker. The eye or gaze tracker may be based on recording pupil movements by a camera pointed towards a user's at least one eye and recording video and/or images at visual or near infrared wavelengths, it may be glint based as it is known in the art. Alternatively or additionally Electro Oclu-Graphic signals may be recorded by electrodes touching the skin around the at least one eye (also known as electrooculography) to provide the eye movement signal.

The eye movement signal represents the naturally occurring optokinetic reflex in human vision and is a combination of a saccade and smooth pursuit eye movements. Such a signal is also denoted an optokinetic nystagmus signal or OKN signal. It is seen when an individual follows a moving object with their eyes, which then moves out of the field of view at which point their eye moves back to the position it was in when it first saw the object. The OKN signal may have a saw-tooth-like pattern that consists of alternating pursuits movements (slow phase) combined with short saccades (fast phase) made in the direction of stimulus. When a user is performing a visual search by looking at a scrolling sequence of contents on a computer screen we can see that the eye follows some objects longer than the others. The longer time the user is following an object of interest, the higher the peak of the slow phase (prolonged smooth pursuit) appears in the eye movement signal.

A prolonged smooth pursuit eye movement may have a duration that is at least 10% or at least 20% longer than an average smooth pursuit eye movement duration or at least 10% or at least 20% longer than a median smooth pursuit eye movement duration. The average smooth pursuit eye movement duration or the median smooth pursuit eye movement duration may be estimated and stored as a constant value or it may be computed/re-computed/updated based on measuring the duration of preceding smooth pursuit eye movement durations.

OKN eye movements occurs when a user looks at a series of moving objects. OKN is a combination of smooth pursuit and saccadic eye movements. When the user follows a moving object in the viewport the smooth pursuit eye movement happens, while saccades return the users' visual attention to the next object appearing in the viewport. The relative amplitude of a smooth pursuit is an indication of the amount of visual attention that the user has paid to each object. A prolonged smooth pursuit will be made when looking at an object that is more interesting to the user. In aspects of the method relatively longer) smooth pursuits (compared to other smooth pursuits is detected to detect the object of interest among other unidirectional moving objects.

A prolonged smooth pursuit creates a bigger peak in the OKN eye movement signal, which may be considered to saw-tooth like. For detecting the prolonged smooth pursuits different classification approaches may be used. For instance a peak detection method based on detecting a signal portion, a.k.a. a peak, when one or more of the criteria are satisfied: the amplitude of the eye movement signal exceeds a fixed or adaptive threshold level, and the slope of a segment of the eye movement signal exceeds a threshold slope. Peak detection may alternatively or additionally be based on other types of peak detection such as wavelet-based peak detection algorithms or by matching known peak shapes to the signal or machine learning techniques.

The eye movement signal may be a continuous analogue signal in the time domain or a sampled digital signal with a sample rate e.g. in the range of 1 to 10 KHz.

In some aspects the amplitude of the eye movement signal indicates the user's gaze. The eye movement signal may comprise relatively small signal excursions that represent a combination of short saccadic and short smooth pursuit eye movements and relatively large signal excursions that represent a combination of large saccadic and prolonged smooth pursuit eye movements. The eye movement signal may be indicative of one or both of the movement in the lateral direction or the horizontal direction.

The synchronization marker may comprise one or more of:
1. a time code e.g. real-time registration of the point in time when a first occurrence of a temporal section classified as a smooth pursuit or a prolonged smooth pursuit eye movement occurred;
2. a data set comprising a time code and a value of or computed from the eye movement signal;
3. a time code and a classification label that indicates the class of the eye movement at least for the first occurrence.

A sequence of synchronization markers may thus be generated, wherein, in case of point 1 above, the marker for the first occurrence may be the first time code, a second occurrence may be a subsequent time code and so forth. In accordance with point 2 above, one or more of the first occurrence and further occurrences may be identified by filtering to select predefined values of the eye movement signal or values computed from the eye movement signal. In accordance with point 3 above, one or more of the first occurrence and further occurrences may be identified by filtering to select predefined classification labels.

In general, a time code is a representation of a point in time kept by a computer system clock as it is commonly known to represent times locally or globally or a representation of a relative point in time computed by a counter running from a reference point in time. The reference point in time may be set e.g. when displaying of the visual media object commences.

Classification may be performed by one or more of: thresholding of the amplitude of the eye movement signal, thresholding the first or higher order derivative of the eye movement signal e.g. to estimate the slope of the eye movement signal at points in time, application of a support vector machine, and a nearest neighbour algorithm. In some aspects signal features e.g. statistical indicators of the eye movement signal is computed to enhance classification. In general signal features with a good time localization are preferred to identify the exact point in time when a slow phase eye movement occurs among the saccadic eye movements.

The link to the contents of the viewport at the point in time when the first occurrence of a smooth pursuit or prolonged smooth pursuit eye movement occurred may comprise one or more of: a graphical offset (Δx) such as an offset measured in pixels; a meta data locator such as a reference to an object identifying the graphical content displayed at the point in time indicated by the first locator e.g. a frame index, a chapter index or the like; or a time code that identifies the graphical content displayed at the point in time indicated by the first locator.

In some aspects the impression information comprises the contents of the viewport as displayed at the point in time when the first occurrence of the smooth pursuit or prolonged smooth pursuit occurred. Alternatively, or additionally, the impression information represents the contents of the viewport in a modified version e.g. obtained by applying a data compression algorithm or by applying graphical effects e.g. to bring the user's attention to the fact that the impression information is a recovered version of the originally presented content, the graphical effects may comprise a shape, size and position manipulation e.g. to display a picture-in-picture version.

In some aspects the visual media object is selected to comprise one or more of: an image, a compound image, a video, a paragraph of formatted text. The visual media object may comprise a style definition e.g. in accordance with a mark-up language such as HTML5.

The visual media object may be a web-page or a page compiled for a predefined application e.g. a social media application such as Facebook®, LinkedIn® or other types of applications.

In some aspects the viewport has a predefined expanse; and wherein rendering makes at least one of the graphical portions appearing within the viewport and then exiting in a sliding movement out of the predefined expanse.

In computer graphics a viewport defines a visible area of a visual media object such as a web-page. The graphical content of the viewport is generated by a process often denoted rendering, whereby portions of the visual media object is given a graphical presentation by a predefined rendering scheme that typically is adapted to the physical capabilities of a display or projector. When scrolling through content of the media file, the viewport is moved across the content as described in more detail below. In an alternative formulation of such scrolling or other type of playing graphical content, the content moves or is moved across the viewport.

The contents of the viewport may be displayed to a user on a computer monitor, on a tablet or smart-phone display, or by a projector to a screen. The viewport defines a visible area of the visual media object. The graphical content of the viewport is generated by a process often denoted rendering, whereby portions of the visual media object is given a graphical presentation by a predefined rendering scheme that typically is adapted to the physical capabilities of a display or projector. Under a predefined rendering scheme the visual media object may be considered to have an expanse, which is wider/larger than the expanse of the viewport. For instance the visual media object may have an expanse of 8000 pixels in height by 1000 pixels in width, and the viewport may have an expanse of 1000 by 1000 pixels, the viewport's position may be defined by a pixel offset along the height dimension, the viewport is progressively moved one pixel at a time or by 10 pixels at a time or at any other number of pixels per time unit. The user may thereby experience a moving presentation of the contents of the visual media object. Rendering may be performed by a rendering engine of the computer.

Rendering may use a predefined speed or predefined speed profile at which the viewport is moved. Rendering may be controlled or modified via a user interface, e.g. to provide a function known as ‘scrolling’, whereby a user scrolls or advances through the contents of the media file in a desired tempo using gestures or pointing devices.

In some embodiments, the eye movement signal represents or is processed to represent mono-directional eye movements either in the sagittal plane or in a plane orthogonal thereto with respect to the user's head.

When the user's head is in a normal upright position, up-down or left-right mono-directional or one-dimensional eye movements can be represented by a one-dimensional signal as a function of time e.g. by its amplitude. This enables fast detection of a smooth pursuit or prolonged smooth pursuit eye movement, while using only reasonable computer processing power. Despite the eye movements are two-dimensional, they may be represented as mono-directional or one-dimensional eye movements and still provide useful information.

In some aspects, the eye movement signal is decomposed into multiple mono-dimensional signals, where one or more of the mono-dimensional signals are processed as set out above.

In case the eye movement signal represents movements along two or more dimensions, smooth pursuit eye movements along two or more of the dimensions may each be processed as set out above, whereby a synchronization marker is set for two of more dimensions. The latter is relevant e.g. if the visual media object is moved or can be selectively scrolled by a user along one or more of two or more dimensions.

In some embodiments, classification is based on detecting a section of a smooth pursuit or prolonged smooth pursuit eye movement by a peak detector. A peak in the eye movement signal is considered to be indicative of a moment of visual interest.

A peak detector enables exact temporal localization of a smooth pursuit or a prolonged smooth pursuit eye movement that is distinguishable from a combination of saccadic and short smooth pursuit eye movements. The exact temporal localization makes it possible to detect moments of interest to the user even at advanced playing or scrolling speeds.

Peak detection may be based on detecting a signal portion, aka a peak, when one or more of the criteria are satisfied: the amplitude of the eye movement signal exceeds a fixed or adaptive threshold level, and the slope of a segment of the eye movement signal exceeds a threshold slope. Peak detection may alternatively or additionally be based on other types of peak detection such as wavelet-based peak detection algorithms or by matching known peak shapes to the signal or machine learning techniques).

In some embodiments, the class of prolonged smooth pursuit eye movement represents a longer smooth pursuit among multiple smooth pursuits; wherein the longer smooth pursuit extends over a longer period of time than other smooth pursuits. The prolonged smooth pursuit class may be defined by thresholding RMS values of peaks in the eye movement signal. Classification methods such as Support Vector Machines may be applied and trained by inputting labels on which phases of multiple smooth pursuits that represent interesting events or objects.

In connection therewith, a peak detector enables exact temporal localization of a prolonged smooth pursuit that is distinguishable from other short smooth pursuits in OKN eye movements. The exact temporal localization makes it possible to detect moments of interest to the user even at advanced playing or scrolling speeds.

In some embodiments, the viewport or the content is advanced at speeds that exceed a threshold speed from one or more of the groups of: 10-60 degrees-of-visual field/second, 10-40 degrees-of-visual field/second, and 15-60 degrees-of-visual field/second.

At sufficiently fast scroll speeds such as those greater than the threshold speeds, the user may only at a later point in time consciously note that something interesting appeared on the display—and at that time the content that was displayed is passed since the viewport was quickly moved to an advanced position. The definition of a prolonged smooth pursuit eye movement at least in terms of temporal extend may be adaptively changed in accordance with the scroll speed.

In some embodiments recording of the synchronization marker comprises:
registering first time codes, running from a reference point in time, at least for points in time when a prolonged smooth pursuit eye movement occurs,
registering second time codes, running from the reference point in time, with an interrelated graphical locator (Δx) that locates the position of the viewport or the visual media content at points in time.

Thereby, a first time code may indicate when a prolonged smooth pursuit eye movement occurs, i.e. when an interesting event occurs. The second time codes can then be searched to look up a second time code which is identical to the first time code or to look up one or more second time codes which is/are closest in time to the first time code and therefrom look up the interrelated graphical locator identical that can locate the position of the viewport or the content at the first point in time.

By the term interrelated is understood that the second time codes are associated with an interrelated graphical locator e.g. by storing the second time code and the graphical locator in the same row of a table or in other data structure as it is known in the art.

In some embodiments the computer-implemented method comprises: while displaying is performed, recording at least one time code and a sequence of graphical locators associated with contents that was rendered in the viewport at points in time represented by the at least one time code. Thereby it is possible to backtrack what the content of the viewport was at a predefined time code. The sequence may be stored in computer memory or in a file in storage.

In some aspects the sequence of graphical locators is generated in real time with displaying of the visual media object to provide a stream of data at a regular e.g. fixed data rate. The sequence of graphical locators may be provided by a rendering engine of a computer graphics component rendering the graphical presentation to be displayed. The at least one time code may be set to represent a system clock value at the point in time when displaying of the graphical media object commences. The graphical locators in the sequence of graphical locators may be registered at equidistant time intervals, e.g. every 1 millisecond. Thereby, it is possible to reveal the content that was displayed at a certain point in time, by deducting how many time intervals to add to the at least one time code to arrive at the certain point in time and then looking up the graphical locator corresponding to the deducted time intervals in the sequence of graphical locators. The graphical locator may be registered e.g. as a number of pixels or a frame number or as another type of graphical locator.

In some aspects the recording comprises recording a sequence of data comprising a time code interrelated with a graphical locator (Δx) associated with contents that was rendered in the viewport at a point in time represented by the time code. In this way pairs of time codes and graphical locators may be generated. Data may be added to the sequence of data as the content of the viewport is changed e.g. by a rendering engine.

In some embodiments recording to the synchronization marker comprises:
registering a time code, running from a reference point in time, at least for points in time when a smooth pursuit section occurs or when a prolonged smooth pursuit section occurs,
setting the reference point in time to a point in time synchronized with a predefined graphical location of the viewport within the visual media object or a predefined graphical location of the visual media object within the viewport.

This is expedient when the spatial and relative temporal location of the viewport is recorded or defined e.g. by a predefined playback speed. The reference point in time may be a point in time at which playback of the visual media object commences. The time code may then be registered at equidistant time intervals or at least for points in time when a prolonged smooth pursuit section occurs. The reference point in time is synchronized with a predefined graphical location of the viewport within the visual media object or a predefined graphical location of the visual media object within the viewport when the reference point in time refers to the predefined graphical location of the visual media content e.g. to a first frame of a video sequence or any other frame count of the video sequence, which may be selected for reference. Thus, by registering the reference point in time and the predefined graphical location together, the reference point in time is synchronized with the predefined graphical location.

In some embodiments temporal sections of the eye movement signal are classified as a section of a graduation of saccadic eye movements or a graduation of smooth pursuit eye movements. This classification may be used in real time or at a later point in time to obtain a filtered set of interesting events.

In some embodiments the computer-implemented method comprises:
computing the frequency of smooth pursuit sections in the eye movement signal;
controlling (speed of the) movement of the viewport in response to the computed frequency of smooth pursuit sections in the eye movement signal.

In some embodiments the computer-implemented method comprises displaying the impression information or the contents of the viewport that was displayed at the point in time when the first occurrence of the smooth pursuit occurred or when the first occurrence of the prolonged smooth pursuit occurred.

In some embodiments the computer-implemented method comprises:
performing a calibration step wherein a user is prompted to direct his gaze at a first reference position and while his gaze dwells there, recording a first signal feature of the eye movement signal; and then the user is prompted to direct his gaze at a second reference position and while his gaze dwells there, recording a second signal feature of the eye movement signal;
adapting classification of the temporal sections of the eye movement signal according to one or both of the first signal feature and the second signal feature.

In some embodiments the computer-implemented method comprises: loading the visual media object. Loading the visual media object may comprise one or more of: loading one or more files from a local storage, or from a memory and downloading from a remote server, e.g. via the Internet.

There is also provided a computer system comprising processing means configured to perform the computer-implemented method as claimed.

There is also provided a computer-readable medium comprising a computer program product performing the computer-implemented method as claimed when loaded into and run by a computer.

The computer-implemented method is an implicit way of using eye gaze since users doesn't have to perform predefined eye-strokes or fixating on a particular target while browsing or scrolling through digital content. The computer-implemented method records and processes natural eye movements for automatically detecting object of interest in a user interface.

The method enables a computer system to automatically detect moving content that seems to be interesting for the user by monitoring and analysing their eye movements. Depending on the application, such a system can for example tag the content of interest in the series of contents or it can immediately react by stopping the content of interest in front of the user's view.

The method provides an attentive scrolling mechanism which analyses the user's natural eye movements subtly and it does not require any explicit command from the user or any change in their gaze behaviour.

Implementation of the method does not necessarily require gaze estimation or calibration between the eye tracker and the display.

Here and in the following, the terms ‘computer’, ‘processing means’ and ‘processing unit’ are intended to comprise any circuit and/or device suitably adapted to perform the functions described herein. In particular, the above term comprises general purpose or proprietary programmable microprocessors, Digital Signal Processors (DSP), Application Specific Integrated Circuits (ASIC), Programmable Logic Arrays (PLA), Field Programmable Gate Arrays (FPGA), special purpose electronic circuits, etc., or a combination thereof.

### BRIEF DESCRIPTION OF THE FIGURES

A more detailed description follows below with reference to the drawing, in which:

FIG. 1 shows a user looking at a display displaying scrolling content;

FIG. 2 is an illustration of the expanse of a viewport moving across the expanse of a visual media object and an eye movement signal;

FIG. 3 shows a flowchart for performing gaze-based event recognition;

FIG. 4 shows an eye movement signal, a detail thereof and temporal segments; and

FIG. 5 is a block diagram implementing a gaze-based event recognition.

### DETAILED DESCRIPTION

When an object catches our visual attention and moves, our eyes try to follow that object closely with corresponding eye movements. These types of eye movements are called smooth pursuit eye movements or simply smooth pursuits. In contrast to other types of eye movements such as saccades, fixations, and blinks, parameters of smooth pursuits are more difficult to measure and are not as stereotyped as saccades. Saccades are generally fast eye movements and they may occur with different amplitude.

Smooth pursuits consist of two phases: initiation and maintenance. Measures of initiation parameters can reveal information about the visual motion processing that is necessary for smooth pursuits. Maintenance involves the construction of an internal, mental, representation of target motion which is used to update and enhance pursuit performance.

In situations of maintenance saccades may occur, for instance with relatively small amplitude, interlaced with a phase of smooth pursuits, caused by the eyes following a moving object. These situations occur possibly because the human visual system uses the saccades to keep focus on a moving object when smooth pursuit eye movements are not sufficient to keep the object ‘tracked’ or in focus. The amplitude of these saccades is the smallest amplitudes. The phase of smooth pursuits, albeit interlaced or connected by saccades with relatively small amplitude may be denoted by the term ‘short slow-phases’.

In some situations, a phase of smooth pursuits as described above is followed by a saccade that brings the gaze back to the gaze point where the phase of smooth pursuits started out. The amplitude of these saccades may be larger than the smallest amplitudes. These saccades may be denoted by the term ‘fast phase’. The phase of smooth-pursuits is also in these situations denoted ‘short slow-phases’

In still other situations, a phase of smooth pursuits as described above is somewhat longer because the user paid particular interest to an object and tried to track it for longer time. A following saccade also denoted a ‘fast-phase’ to bring the gaze back to the gaze point where the phase of smooth pursuit started out, accordingly has larger amplitude. Particularly, when the object is an object displayed on a display screen, the amplitude of the saccades is limited according to a viewing angle range given by the size of the display screen and its distance from the user's eyes. In these situation, wherein the user paid special interest, the phase of smooth pursuits, albeit interlaced or connected by saccades with relatively small amplitude may be denoted by the term ‘long slow-phases’. The term ‘long slow-phases’ refers to smooth-pursuits maintained for a longer period of time than those denoted ‘short slow-phases’ over”. The ‘long slow-phases’ may be distinguished over ‘short slow-phases’ in that the RMS value of their peak values is greater than the RMS value of peaks in the ‘short slow-phases’.

The above observations are exploited as explained in more detail below.

When we look at a series of linearly moving images, and we search for a particular image e.g. by scrolling through images in a digital album, our eyes perform a combination of saccadic and smooth pursuit eye movements (a.k.a Optokinetik Nystagmus Eye Movements or OKN). It is discovered that the smooth pursuit eye movements are relatively short when our eyes do not see an interesting image, thus a short slow-phase can be observed. As soon as an image draws our attention, the maintenance phase of the smooth pursuit eye movement gets longer since our brain wants to get more details about that image, thus a long short slow-phase can be observed.

By the present computer-implemented method the difference between smooth pursuit or slow-phase lengths when the eyes are looking for an interesting object and smooth pursuit lengths when an object catches our attention is utilized.

In a visual search task among a series of unidirectional moving objects such as images, the objects move linearly and in the same direction; therefore, the most relevant feature is the eye movements in the same direction as the moving objects.

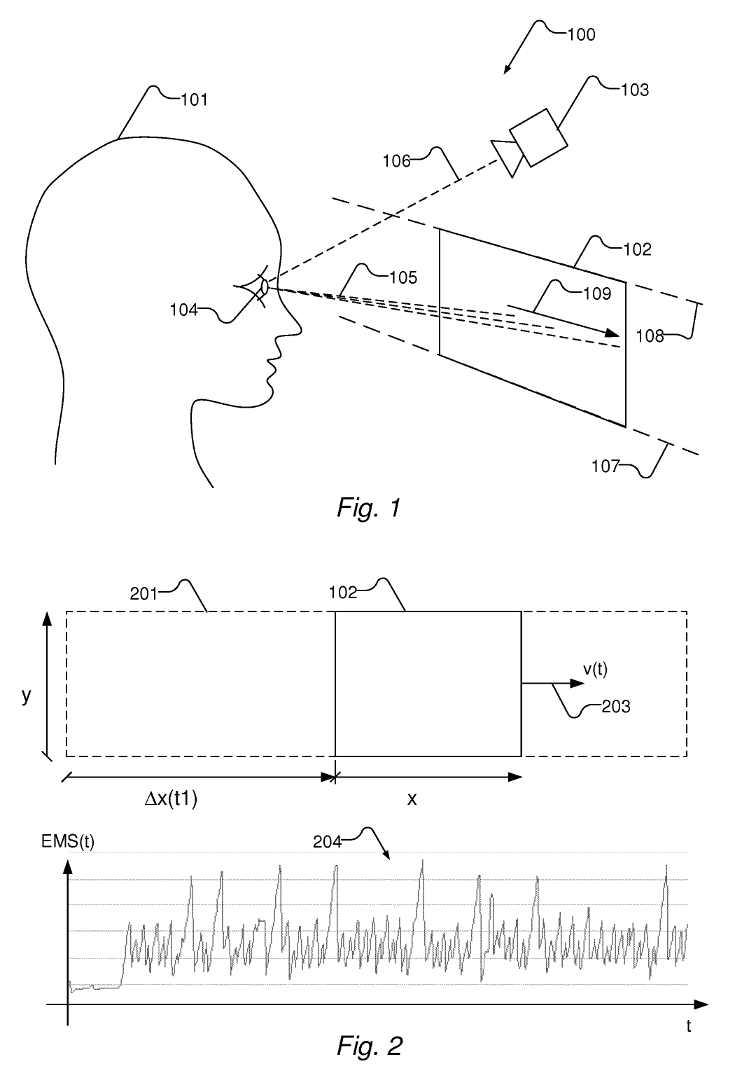

FIG. 1 shows a user 101 looking at a viewport 102 that displays scrolling or otherwise moving content that moves from left to right in the direction indicated by arrow 109. A camera 103 captures the eye movement or the gaze direction. When the scrolling content moves from left to the right side of the viewport, the viewers' at least one eye 104 tend to follow or track the motion of the content continuously. Since the user's head remains stationary, i.e. substantially in the same position, the user's eye gaze 105 moves horizontally in the same direction and at the same speed as the moving content.

The viewport may be displayed by a display such as a LED matrix display or by a projector projecting an image of the viewport onto a screen. An electronic device such as a smart phone, tablet, laptop, a stationary computer, a head-mounted display device, or television, e.g. a so-called smart-TV, may comprise the display or projector as it is known to a person skilled in the art.

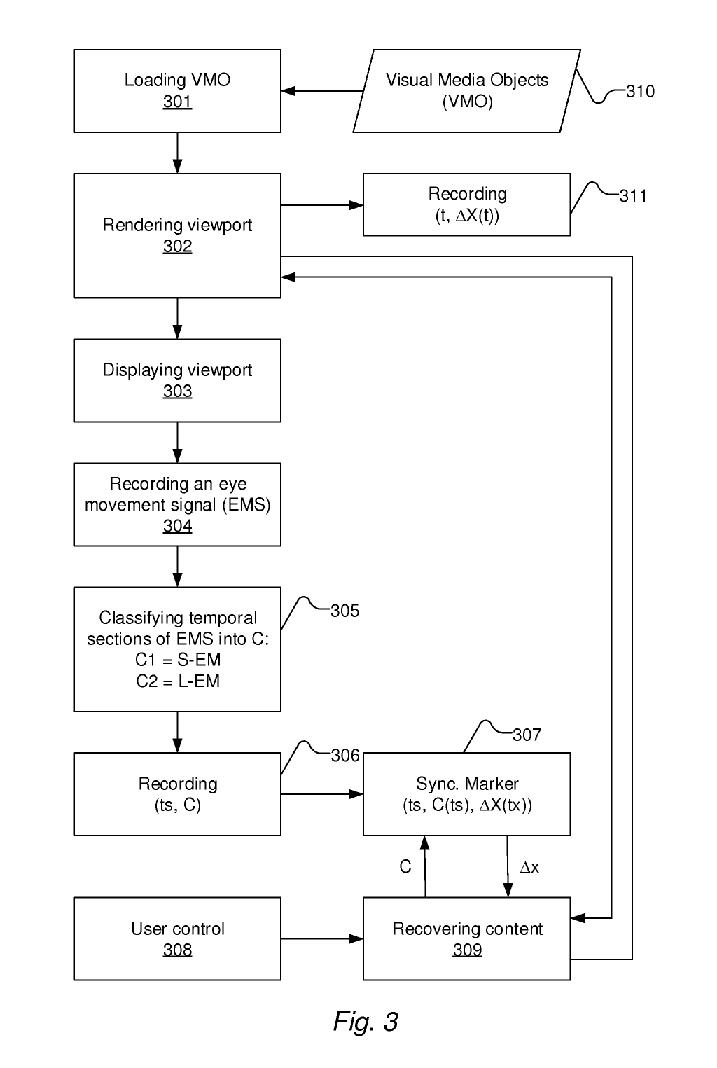

FIG. 2 is an illustration of the expanse of a viewport moving across the expanse of a visual media object and an eye movement signal.

It should be noted that the term ‘viewport’ is a data structure that stores the content being displayed on a physical display. Thus, when it is stated that the viewport is moving or is moved, it refers to its content being changed over the course of time to present content that changes over time. Likewise, a data structure holds the content of the visual media object—the expanse of the visual media object corresponds to laying out the contents of the visual media object spatially as it would be rendered in the viewport over time.

Alternatively, the presentation in the viewport could be described in the context of the visual media object being moved relative to the viewport. This could correspond to a strip of film being moved and one image on the strip of film being visible at any one time.

The viewport 102 has an expanse indicated by geometrical dimensions ‘x’ and ‘y’ which may correspond to the size, e.g. measured in pixels, of a display for which the content of the viewport 102 is intended. The viewport is moved at a speed v(t) as a function of time, t, indicated by arrow 203. The speed v(t) may be constant while the viewport is moved across the visual media object 201 or time varying. This is one of several ways to illustrate scrolling or playback of a visual media object or a sequence of visual media objects.

At a point in time, t1, the viewport 102 appear at a position Δx(t1) in the visual media object. This particular position, Δx(t1), and thus the content of the viewport 102 at this particular position may be recovered at a point in time following time t1. One way is to record tuples of time stamps and Δx(t) values at all time instances at which the viewport is rendered or at selected time instances and then recover the content of the viewport 102 as it occurred at time t1 using time t1 to look up Δx(t1) which is the position in the visual media object holding the content of the viewport as it occurred at time t1.

Another way is to record timestamps running relative to the point in time when the viewport 102 was at a registered start point with respect to the visual media object and then recover the content of the viewport 102 as it occurred at time t1 using t1 to compute Δx(t1) assuming speed v(t) is/was constant or at least known at various points in time. Another term for recover in this respect is regenerate. It should be noted that the visual media object may comprise audio or other media types as it is known in the art.

The visual media object or the sequence of portions of the visual media revealed by the viewport over time may also be denoted a visual media stream or a stream.

The eye movement signal, EMS(t) is shown in a Cartesian coordinate system wherein the abscissa (x-axis) represents time, t, and wherein the ordinate (y-axis) represents signal amplitude, i.e. the excursion of eye movements, as a function of time, EMS(t). The eye movement signal shows a saw-tooth like pattern of the optokinetic reflex, OKN, eye movement which in this illustration corresponds to the horizontal eye movements of a viewer looking at the moving visual media. It can be seen that the saw-tooth like signal comprises a multitude of triangular peaks with different amplitudes. The steep right hand side slopes, which are almost vertical, of the triangular peaks represents fast-phases; whereas the less steep, left hand side, slopes represents slow-phases. As can be seen the eye movement signal comprises short slow-phases and long slow-phases, both followed by a fast-phase.

FIG. 3 shows a flowchart for performing gaze-based event recognition. As a first step, visual media objects 310 are loaded in step 301 from either a static repository or an online Internet services such as Facebook. The visual media objects may comprise images, video, animations, text or other types of digital visual content. Objects may be comprised by another object such as a file object. The term ‘object’ represents visual content whether it is implemented in an object oriented technology or not.

The visual media objects are rendered in the viewport in step 302 in connection with creating scrollable visual content from the visual media objects 310. The scrollable visual content comprises a series of visual media objects 310 to be displayed in the viewport. The viewport can be displayed through a computer screen, smartphone, near-eye display, projector, or any other device which is able to display the visual media objects.

As the visual media objects 310 scroll in the viewport, an eye tracker records an eye movement signal (EMS) in step 304 for classifying temporal sections of eye movement signal in step 305. One class, C1, denoted S-EM may represent small eye movements. Another class, C2, denoted L-EM may represent large eye movements or a complex of large eye movements. Both classes C1 and C2 may comprise a complex of saccadic and smooth pursuit eye movements. Classification methods known in the art can be used for this purpose. Classification methods may comprise one or more of threshold-based methods, peak-detection methods and support vector machines as examples. Additional classes may be used.

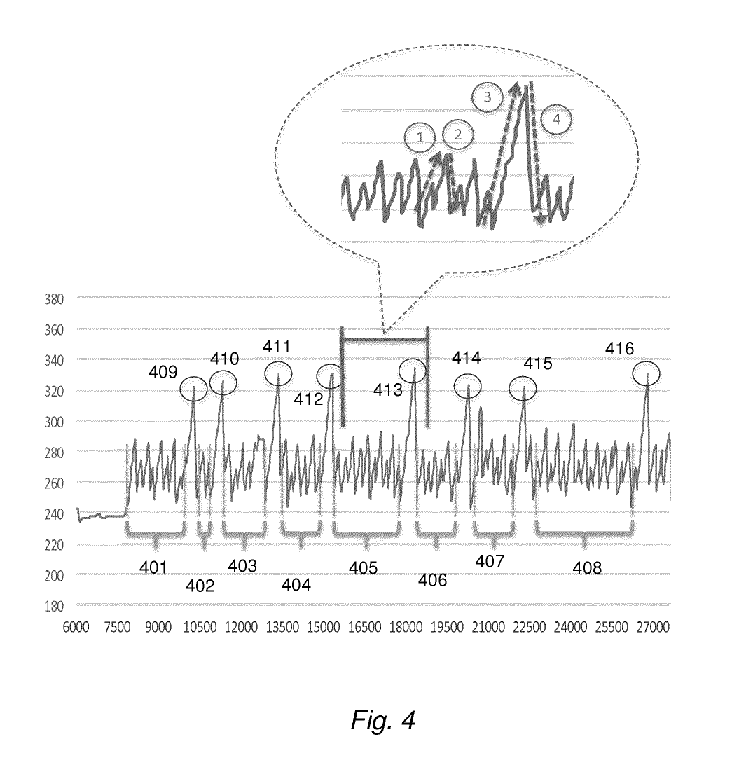

An event may be detected from the classification obtained e.g. located in time to the point in time when a signal complex classified in class C2, representing large eye movements, occurred. An event may be detected from the classification obtained e.g. from a peak-detector configured to detect a complex of a smooth pursuit movement or a large or prolonged smooth pursuit movement followed by a large saccadic movement among smaller eye movements as illustrated in more detail in connection with FIG. 4.

When an event is detected, the point in time the event occurs or occurred is recorded in step 306. In connection therewith, the tuple (ts, C) represents time or a timestamp by ‘ts’, and a corresponding classification class by ‘C’. This tuple may be stored at least temporarily to represent the event. In some embodiments it is sufficient to store a timestamp, ts.

In some embodiments, classification into a selected class e.g. class C2, may cause immediate recover of the content that was displayed in the viewport at or about the point in time when the signal complex was classified. In this case, scrolling through or playback of the visual media objects may be temporarily halted or re-winded to recover the content displayed when the signal complex was classified. Immediate recover of the content may be selected as an option via a user control step 308. Thus classification is performed while scrolling or playback takes place and at a sufficient fast rate to not lose track of the content at a given scrolling speed or playback speed.

In other embodiments, classification into a selected class e.g. class C2, causes storage of time stamps, ts, and optionally a classification of a signal complex occurring at the point in time of the time stamp. Recover of the content at one or more point in time may then be performed at a later point in time, e.g. when playback or scrolling through the visual media objects 310 is competed or is about to be completed. Classification may then be performed at a slower rate and continue beyond a point in time when conventional scrolling or playback is complete.

The position (Δx(t)) of the viewport at points in time, t, is recorded in step 311 as a while the viewport is rendered in step 302 as explained above in connection with FIG. 2.

A synchronisation marker comprising (ts, Δx(ts)) and optionally the class C at time ts, is stored in step 307. A value of Δx(ts) is retrieved by consulting the recording performed in step 311. The content can then be recovered in step 309 and rendered in the viewport again in step 302.

FIG. 4 illustrates an Optokinetic Nystagmus (OKN) eye movement signal sampled while a user views a set of unidirectional moving images or other type of objects that move from the right to the left side of the screen. The eye movement signal is shown in a Cartesian coordinate system, wherein the example values 180 through 380 along the ordinate (y-axis) indicate relative amplitude of the eye movement at a random scale, and wherein the example values 6000 through 27000 along the abscissa (x-axis) indicate time instances of sampling.

The eye movement signal is generated from horizontal eye movements during a visual search task, wherein the signal is acquired on a user while performing a search for an image. The eye movement signal shows a saw-tooth pattern of the OKN eye movement that consists of two general phases:
1. A first phase with slow and small eye movements which occurs when a user's eye follows a moving image by a smooth pursuit eye movement as indicated by encircled reference numerals 1 and 3 along the scrolling direction;
2. A second phase which is a fast and large compensatory eye movement as indicated by encircled reference numerals 2 and 4 in the opposite direction of the scrolling direction.

The OKN pattern comprises a combination of both saccadic and smooth pursuit eye movements with different amplitudes and durations.

Reference numerals 401, 402, 403, 404, 405, 406, 407 and 408 represent periods of the eye movement signal comprising short smooth pursuit movements that happen when eyes are scanning among moving images. During the sections 401 through 408, the eyes follow a series of images one by one, each for a short time during a short slow-phase, quickly returning the gaze over a fast-phase. When there is no interesting information in the picture, eyes stop following that picture and after a short slow-phase or saccade 2, the eyes move back to their initial position in right area of the screen, by a fast-phase, to scan following images. When a picture draws user's visual attention, the user's eyes follow that picture for a longer time (a long smooth pursuit or long slow-phase) which leads to an extreme peak in the signal 3. The extreme peaks are designated by reference numerals 409, 410, 411, 412, 413, 414, 415 and 416.

After a long smooth pursuit 3, a long saccade 4 takes the gaze back to the right area of the screen to scan next images. This takes place at the extreme peaks 409 through 416.

The short saccadic and smooth pursuit eye movements which happen in the first phase of the visual search task are clearly visible. The longer smooth pursuit movements occur when an object draws users' attention. In this phase of visual search, eyes follow the object of interest for a longer time which generates a peak in the signal. By detecting the moment and location of this peak in the signal, we are able to recognize the object of interest among other moving objects.

Thus, events may be detected by comparing samples of the eye movement signal to a threshold value e.g. a fixed threshold value set at a value in the range 300 to 320. The threshold may be set dynamically to be located outside an amplitude envelope of the signal defined during periods of short smooth pursuit movements cf. reference numerals 401 through 408. The event may alternatively and/or additionally be detected by a peak-detector as it is known in the art.

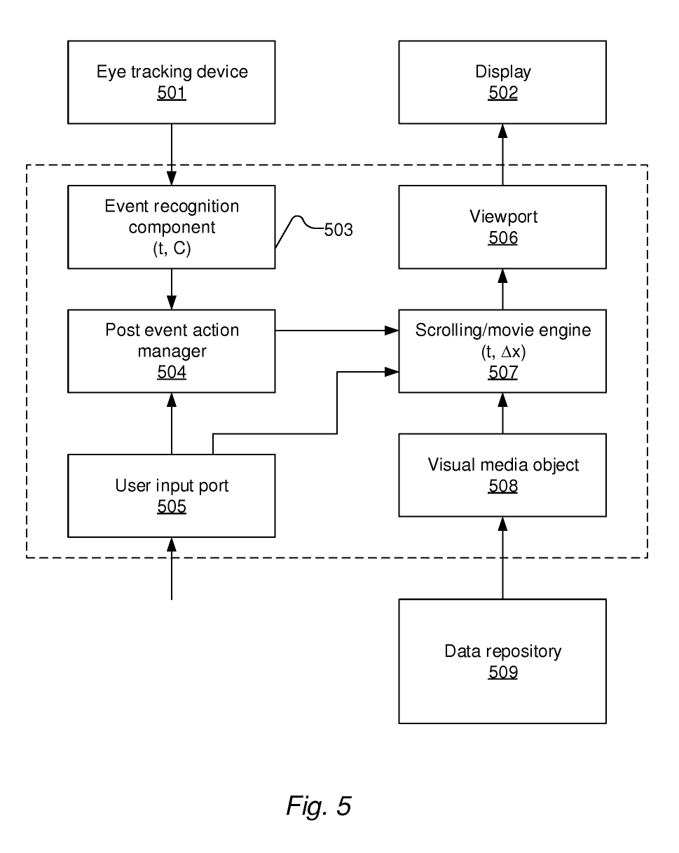

FIG. 5 is a block diagram implementing gaze-based event recognition. The configuration comprises a display 502 which shows the viewport 506 with scrolling visual media content. The visual media content includes visual media objects 508 stored in a data repository 509. The data repository can be either static or dynamic (e.g. updated in real-time using online content from the Internet). When a user looks at the scrolling content, the eye tracking device 501 captures the user's eye movements as eye movement data also denoted an eye movement signal. The eye tracking device 501 can be a camera-based eye tracker, or an EOG-based eye tracker, or it can be based on any other eye tracking technology to detect the user's eye movements. When or as the eye movement data are captured, data are sent to the event recognition component 503. The event recognition component 503 analyses the eye movement data to find smooth pursuit eye movements, such as prolonged smooth pursuit eye movements, in the eye movement signal. To classify the smooth pursuit eye movements, such as the prolonged smooth pursuit eye movements, the event recognition component can use either machine learning approach or adjusting threshold for speed and length of the eye movements. As soon as detecting an event, the event recognition component 503 sends a signal to the post event action manager 504 to react to the event accordingly. For example, in the stop-scrolling embodiment, the post event action manager stops or changes the speed of scrolling through scrolling engine 507. After changing the scrolling speed, the viewer can start scrolling again through user input port 505. The viewer can send command to the user input port 505 through different modalities such as head gestures, voice commands, hand gestures, pressing a button, etc.

In some embodiments there is provided a computer-implemented method of recovering a visual event, comprising: by means of a graphical user interface, the contents of a viewport is displayed to a user as the stream of visual media objects is progressively moved relative to the viewport; while the contents of the viewport is displayed, recording an eye movement signal that is indicative of the movements of a user's at least one eye; classifying temporal sections of the eye movement signal into at least a class of smooth pursuit eye movements or prolonged smooth pursuit eye movements occurring among saccadic eye movements or among short smooth pursuit and saccadic eye movements; setting a synchronization marker at least for a first occurrence of a temporal section classified as a long slow phase in OKN eye movements; wherein the synchronization marker comprises a link to or impression information of the contents of the viewport at the point in time when the first occurrence of a smooth pursuit or prolonged smooth pursuit eye movement occurred; and via the synchronization marker, recovering the impression information or the contents of the viewport that was displayed at the point in time when the first occurrence of the long slow phase in OKN eye movements occurred.

In some embodiments there is provided a computer-implemented method of recovering a visual event, comprising: by means of a graphical user interface, the contents of a viewport is displayed to a user as the viewport is progressively moved across graphical portions of a visual media object; while the contents of the viewport is displayed, recording an eye movement signal that is indicative of the movements of a user's at least one eye, classifying temporal sections of the eye movement signal into at least a class of long slow-phase (long smooth pursuit eye movements) occurring among short slow-phase and saccadic eye movements; setting a synchronization marker at least for a first occurrence of a temporal section classified as a smooth pursuit or prolonged smooth pursuit eye movement; wherein the synchronization marker comprises a link to or impression information of the contents of the viewport at the point in time when the first occurrence of a long slow-phase (long smooth pursuit eye movement) occurred; via the synchronization marker, recovering the impression information or the contents of the viewport that was displayed at the point in time when the first occurrence of the smooth pursuit or prolonged smooth pursuit occurred.

Herein, the terms ‘saccadic’ and ‘saccadial’ are used interchangeably.

### Items:

1. A computer-implemented method of recovering a visual event, comprising:
by means of a graphical user interface, the contents of a viewport is displayed to a user as the viewport is progressively moved across graphical portions of a visual media object;
while the contents of the viewport is displayed, recording an eye movement signal that is indicative of the movements of a user's at least one eye,
classifying temporal sections of the eye movement signal into at least a class of smooth pursuit eye movements occurring among eye movements;
setting a synchronization marker at least for a first occurrence of a temporal section classified as a smooth pursuit eye movement; wherein the synchronization marker comprises a link to or impression information of the contents of the viewport at the point in time when the first occurrence of a smooth pursuit eye movement occurred;
via the synchronization marker, recovering the impression information or the contents of the viewport that was displayed at the point in time when the first occurrence of the smooth pursuit occurred.
2. A computer-implemented method according to item 1, wherein the eye movement signal represents or is processed to represent mono-directional eye movements either in the sagittal plane or in a plane orthogonal thereto with respect to the user's head.
3. A computer-implemented method according to item 1 or 2, wherein classification is based on detecting a section of a smooth pursuit eye movement by a peak detector.
4. A computer-implemented method according to any of items 1-3, wherein the class of smooth pursuit eye movements represents a multiple smooth pursuits; wherein the extends over a longer period of time smooth pursuits.
5. A computer-implemented method according to any of items 1-4, wherein recording of the synchronization marker comprises:
registering first time codes, running from a reference point in time, at least for points in time when a smooth pursuit eye movement occurs,
registering second time codes, running from the reference point in time, with an interrelated graphical locator (Δx) that locates the position of the viewport at points in time.
   6. A computer-implemented method according to any of items 1-5, comprising: while displaying is performed, recording at least one time code and a sequence of graphical locators (Δx) that was rendered in the viewport at points in time represented by the at least one time code.
   7. A computer-implemented method according to any of items 1-6, wherein recording to the synchronization marker comprises:
registering a time code, running from a reference point in time, at least for points in time when a smooth pursuit section occurs,
setting the reference point in time to a point in time synchronized with a predefined graphical location of the viewport within the visual media object.
   8. A computer-implemented method according to any of items 1-7, wherein temporal sections of the eye movement signal are classified as a section of a graduation of eye movements or a graduation of smooth pursuit eye movements.
   9. A computer-implemented method according to any of items 1-8, comprising:
computing the frequency of smooth pursuit sections in the eye movement signal;
controlling (speed of the) movement of the viewport in response to the computed frequency of smooth pursuit sections in the eye movement signal.
   10. A computer-implemented method according to any of items 1-9, comprising: displaying the impression information or the contents of the viewport that was displayed at the point in time when the first occurrence of the smooth pursuit occurred.
   11. A computer-implemented method according to any of items 1-10, comprising:
performing a calibration step wherein a user is prompted to direct his gaze at a first reference position and while his gaze dwells there, recording a first signal feature of the eye movement signal; and then the user is prompted to direct his gaze at a second reference position and while his gaze dwells there, recording a second signal feature of the eye movement signal;
adapting classification of the temporal sections of the eye movement signal according to one or both of the first signal feature and the second signal feature.
   12. A computer-implemented method according to any of items 1-11, comprising: loading the visual media object.
   13. A computer system comprising processing means configured to perform the method set out in any of items 1-10.
   14. A computer-readable medium comprising a computer program product performing the method set out in any of items 1-10 when loaded into and run by a computer.
   15. A computer-implemented method of recovering a visual event, comprising:
   by means of a graphical user interface, the contents of a viewport is displayed to a user as the viewport is progressively moved across graphical portions of a visual media object or the graphical portions of a visual media object are progressively moved across a viewport;
   while the contents of the viewport is displayed, recording an eye movement signal that is indicative of the movements of a user's at least one eye;
   classifying temporal sections of the eye movement signal into at least a class of prolonged smooth pursuit eye movements occurring among a combination of short saccadic and short smooth pursuit eye movements;
   setting a synchronization marker at least for a first occurrence of a temporal section classified as a prolonged smooth pursuit smooth pursuit eye movement; wherein the synchronization marker comprises a link to contents of the viewport at the point in time when the first occurrence of a prolonged smooth pursuit eye movement occurred or impression information of the contents of the viewport at the point in time when the first occurrence of a prolonged smooth pursuit smooth pursuit eye movement occurred; and
   via the synchronization marker, recovering the impression information or the contents of the viewport that was displayed at the point in time when the first occurrence of the prolonged smooth pursuit smooth pursuit occurred.

1. A computer-implemented method of recovering a visual event, comprising:
by means of a graphical user interface, the contents of a viewport is displayed to a user as the viewport is progressively moved across graphical portions of a visual media object or the graphical portions of a visual media object are progressively moved across a viewport;
while the contents of the viewport is displayed, recording an eye movement signal that is indicative of the movements of a user's at least one eye;
classifying temporal sections of the eye movement signal into at least a class of smooth pursuit eye movements occurring among saccadic eye movements;
setting a synchronization marker at least for a first occurrence of a temporal section classified as a smooth pursuit eye movement; wherein the synchronization marker comprises a link to contents of the viewport at the point in time when the first occurrence of a smooth pursuit eye movement occurred or impression information of the contents of the viewport at the point in time when the first occurrence of a smooth pursuit eye movement occurred; and
via the synchronization marker, recovering the impression information or the contents of the viewport that was displayed at the point in time when the first occurrence of the smooth pursuit occurred.

2. A computer-implemented method according to claim 1, wherein the eye movement signal represents or is processed to represent mono-directional eye movements either in the sagittal plane or in a plane orthogonal thereto with respect to the user's head.

3. A computer-implemented method according to claim 1,
wherein the an eye movement signal is an Optokinetic Nystagmis eye movement signal;
and wherein classification is based on detecting a section of a smooth pursuit eye movement by a peak detector which detects peaks in the eye movement signal.

4. A computer-implemented method according to claim 1, wherein a class of prolonged smooth pursuit eye movements represents a peak among multiple smooth pursuits; wherein the prolonged smooth pursuits has varying durations of time.

5. A computer-implemented method according to claim 1, wherein recording of the synchronization marker comprises:
registering first time codes, running from a reference point in time, at least for points in time when a smooth pursuit or prolonged smooth pursuit eye movement occurs,
registering second time codes, running from the reference point in time, with an interrelated graphical locator (x) that locates the position of the viewport at points in time.

6. A computer-implemented method according to claim 1, comprising: while displaying is performed, recording at least one time code and a sequence of graphical locators (x) associated with contents that was rendered in the viewport at points in time following points in time represented by the at least one time code.

7. A computer-implemented method according to claim 1, wherein setting the synchronization marker comprises:
registering a time code, running from a reference point in time, at least for points in time when a smooth pursuit section or prolonged smooth pursuit section occurs,
setting the reference point in time to a point in time synchronized with a predefined graphical location of the viewport within the visual media object.

8. A computer-implemented method according to claim 1, wherein temporal sections of the eye movement signal are classified as a section of a graduation of saccadic eye movements or a graduation of smooth pursuit eye movements.

9. A computer-implemented method according to claim 1, comprising:
computing the frequency of smooth pursuit sections in the eye movement signal;
controlling speed of the movement of the viewport or the visual media object in response to the computed frequency of smooth pursuit sections in the eye movement signal.

10. A computer-implemented method according to claim 1, wherein the smooth pursuit eye movement is a prolonged smooth pursuit eye movement.

11. A computer-implemented method according to claim 1, comprising:
performing a calibration step wherein a user is prompted to direct his gaze at a first reference position and while his gaze dwells there, recording a first signal feature of the eye movement signal; and then the user is prompted to direct his gaze at a second reference position and while his gaze dwells there, recording a second signal feature of the eye movement signal;
adapting classification of the temporal sections of the eye movement signal according to one or both of the first signal feature and the second signal feature.

12. A computer-implemented method according to claim 1, comprising: loading the visual media object.

13. A computer system comprising: a sensor for recording eye or gaze movement signal and a processor configured to perform the method set out in claim 1.

14. A computer-readable medium comprising a computer program product performing the method set out in claim 1 when loaded into and run by a computer.
